(19) United States
(12) Patent Application Publication
(10) Pub. No.: US 2006/0262775 A1
(43) Pub. Date: Nov. 23, 2006

(54) Method for controlling highly accessible user access networks via a packet-based network service point

(76) Inventor: Norbert Lobig, Darmstadt (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/569,782

(22) PCT Filed: May 4, 2004
(86) PCT No.: PCT/EP04/50695

§ 371 Date: Feb. 24, 2006

(30) Foreign Application Priority Data
Aug. 26, 2003 (DE) 103 39 279.3

(51) Int. Cl. H04L 12/66; H04L 12/56

(52) U.S. Cl. 370/352; 370/401

(57) ABSTRACT

Access gateways in a packet-based network known in prior art have to log onto media gateway controllers that control said access gateways via standard protocols. The problem with said process is that switching to equivalent redundant devices takes too long. In order to minimize the time it takes to switch to equivalent devices, the access gateway simultaneously logs onto the at least two media gateway controllers such that at least two packet-based signaling connections are established while only one thereof is activated from the point of view of network services for the same plurality of users according to a specific selection criterion

### CROSS REFERENCE TO RELATED APPLICATIONS

This application is the US National Stage of International Application No. PCT/EP2004/050695, filed May 04, 2004 and claims the benefit thereof. The International Application claims the benefits of German application No. 10339279.3 DE filed Aug. 26, 2003, both of the applications are incorporated by reference herein in their entirety.

### FIELD OF INVENTION

The invention relates to a method according to the independent claim.

### BACKGROUND OF INVENTION

Modern communication architectures that employ packet-based or cell-based methods such as, for example, Voice-over-IP (VoIP) or Voice-over-ATM (VoATM) for transmitting voice signals provide for separating the transmission of signaling information and useful information. The networks are for this purpose divided into units serving to transport the useful information (bearers) and units for controlling these useful connections (bearer control). To continue making communication with conventional circuit-switched telecommunication networks possible, “translating” between said two different communication architectures is necessary that is carried out in coupling points. The useful connections are converted at a coupling point of said kind by means of special servers, referred to as media gateways, into the transport technology employed. Media gateways thus have interfaces to both PSTN/ISDN and IP/ATM networks and hence form the interfaces between circuit-switching and packet-oriented networks. Said gateways can convert TDM (Time Division Multiplexing) voice data into VoIP/VoATM data, and vice versa, in realtime.

The media gateways are controlled by central instances, namely the media gateway controllers (MGC) or call feature servers. These serve essentially to coordinate the media gateways; they also monitor/control connections (bearer connections) between the media gateways. Controlling is carried out with the aid of special protocols such as the MGCP (Media Gateway Controller Protocol) or H.248 protocol.

Communication between two or more subscribers, such as, for instance, ISDN/PSTN subscribers, conducted hitherto over conventional circuit-switched telecommunication networks can thus be conducted over IP networks. As terminals it is possible to use, for example, conventional ISDN/PSTN terminals connected to terminating devices IAD (Integrated Access Devices) of xDSL links or to terminating devices MTA (Multimedia Terminal Adapter) in/behind cable modems, or IP-based terminals with corresponding IP-based signaling (H.323/SIP).

Because communication systems/networks have hitherto been realized on a TDM/IP/(ATM) basis, from the standpoint of the underlying philosophy there are now major differences between, for example, TDM-based and IP-based networks:

In the TDM world the interfaces, connected to a switching center, to subscriber concentrators and access networks are controlled exclusively by said center. Although the devices (subscriber line concentrator or access network) near the subscriber can influence any switchover to equivalent devices that takes place, the switching center, by which alone it is decided how said first-cited devices are to be operated, nevertheless remains the supreme instance (the V5.2 interface is an example thereof).

In the IP-based world the access gateway corresponding to the access network and having the function of a media gateway is free to alternatively log on to a plurality of switching centers. The access gateway/media gateway in any event logs on to a packet-based switching center (media gateway controller or call feature server) and can henceforth perform switching operations therewith. Said center is at the same time non-existent for further packet-based switching centers and also non-addressable. (Examples of this are access gateways and media gateway controllers which communicate via an H.248 protocol).

The cited differences in philosophy between the TDM and IP worlds have serious consequences. These in particular affect methods of equivalent switchover between the access gateways/media gateways and the devices (media gateway controller or call feature server) controlling them. The packet-based switching center (media gateway controller or call feature server) for the direct processing of subscriber signals is herein embodied as a network element corresponding to a conventional, local switching center. Said packet-based switching center is consequently faced on the subscriber side with a plurality of subscriber access networks (access gateway [AGW]) that can be addressed by the packet network and are controlled via peripheral devices by media gateway controllers. The failure of a peripheral device will as a rule be detected very quickly in a media gateway controller of said type, which will result in switchover to the equivalent redundant peripheral device.

Since, however, the redundant peripheral devices each have their own packet address, this means on the one hand that, viewed from the access gateway/media gateway, there will be a total of two media gateway controllers; on the other hand there will be a change in packet address for communication with the access gateway/media gateway due to switchover to an equivalent device, resulting in temporary loss of communication with the media gateway controller for the connected access gateway/media gateway. As a result of this loss of communication with the media gateway controller it is then necessary for the access gateway/media gateway to detect said loss and switch over independently to the redundant peripheral device configured for operation. The earliest time, though, at which equivalent switchover (reregistering on the redundant peripheral device) takes place is after a protection time of 30 s (in the case of the H.248 protocol). This serves to bridge IP network faults that must not result in undesired equivalent switchover in order not to become sensitive through temporary network faults to undesired switching back and forth between a media gateway controller's redundant peripheral devices.

### SUMMARY OF INVENTION

What is problematic in this prior art is that the subscribers/trunk lines are inaccessible for the length of time changeover is in progress. Stable connections and signaling messages alike can be lost. Incorrect charge accounting due to overlong equivalent switchover times is just as undesirable as the outage of stable connections. While still definitely tolerable for data transmissions, said equivalent switchover times are totally unacceptable for video transmissions or even voice transmissions.

An object of the invention is therefore to disclose a way whereby the media gateway of a packet-based network can be controlled by a media gateway controller in such a way that the equivalent switchover times can be minimized in the event of equivalent switchover.

Said object is achieved, proceeding from the features indicated in the the claims.

A major advantage of the invention can be seen in the speed of changeover. This is achieved by means of the media gateway controller which controls switchover to the redundant protocol interfaces when a peripheral device of the packet-based switching center fails. Having already been initialized, the redundant protocol interface can be used for switching operations immediately after the failure, and with no time delay. This minimizes/avoids the non-accessibility or non-operability of subscribers at the access gateway/media gateway. Stable connections will hereby not have to be released even owing to potentially incorrect charge accounting. The invention basically offers a simple, robust solution that features high subscriber availability and can manage with only little support from the access gateway/media gateway.

A further advantage of the invention can be seen in its avoidance of expensive implementations, for example that of offering the redundancy of the peripheral devices with the characteristic of a single packet-based address in the direction of the media gateway and of being able to replicate the current interface data (for example the media gateway's packet address and port number) onto a peripheral device assuming the performance of switching operations.

Another advantage is that alternative solutions coupled to proprietary protocol expansions and to changes to the functionality of the protocol stack (which, incidentally, would mean a change to the philosophy) are likewise avoided. The interfaces used remain, viewed per se, fully standard-compliant and proprietary expansions are unnecessary.

A particular advantage of the invention can be seen in its universal applicability. The method can be applied to any packet-based signaling protocols such as, for example, H.248, H.323, SIP, or SIP-T. Network outages ahead of the edge router on the packet-based switching system are, furthermore, covered. The method can also be used in the same way for pure trunk gateways and packet-based servers (IVR, conference, media server).

Advantageous developments of the invention are described in the dependent claims.

For example, the reliability of the access gateway/media gateway can be increased by exchanging cyclical test messages (auditing) of the redundant interface and through, where applicable, corresponding operator alerting. Further embodiments are the introduction of n:1 redundancy of the redundant peripheral devices, load sharing operation via the redundant protocol interfaces, the provision of virtual access gateways/media gateways having the above-described interfaces, additive call-context replication (including stack components) for rescuing stable and transient connections, and the automatic switchback of access gateways/media gateways following the repair of a peripheral device to enhance the packet-based switching center's connectability (avoidance of peripheral devices in the pure standby condition).

### BRIEF DESCRIPTION OF THE DRAWINGS

The invention is explained in more detail below with reference to a figured exemplary embodiment:

FIG. 1 shows the basic conditions when an access gateway/media gateway is linked to a media gateway controller

FIG. 2 shows a configuration on which the inventive redundant changeover operations are carried out

FIG. 3 shows the linking of a plurality of access gateways/media gateways to a media gateway controller.

### DETAILED DESCRIPTION OF INVENTION

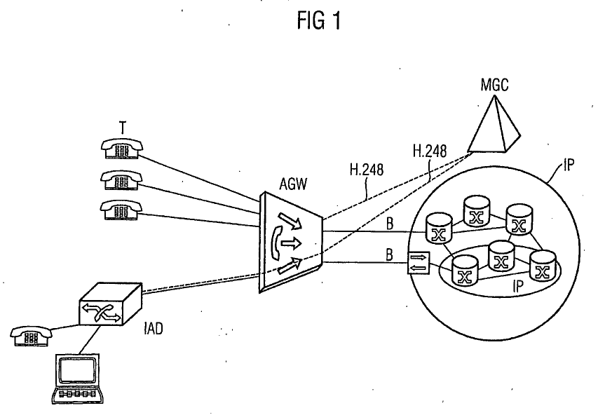

FIG. 1 shows an internet network IP which has been brought via bearer connections B to a media gateway. The latter is embodied as an access gateway AGW and is connected on the subscriber side to ISDN/PSTN subscribers T. The number (several thousand) of PSTN and ISDN subscriber connections that is known from access networks and subscriber concentrators can typically be attained here. The access gateway AGW is furthermore connected to IAD terminating devices that can have the function of a media gateway. The access gateway AGW is connected by way of example via an H.248 protocol to a packet-based switching center MGC. This is also called a media gateway controller, call feature server, call control server or, specifically in conjunction with the H.323 protocol, a gatekeeper. According to the present exemplary embodiment an H.248 protocol is used. The H.248 signaling shown in FIG. 1 is logically ducted in the illustrated manner between the access gateway AGW/IAD and the packet-based switching center MGC. The signaling path is in reality also ducted via the internet network IP, although for a clearer presentation of FIG. 1 this is not shown explicitly.

It should basically be noted that the embodying of the media gateway as an access gateway is purely exemplary: Instead of access gateways, trunk gateways with trunk lines and without subscribers or access gateways with subscribers and without trunk lines can be used just as well. If the cited gateways have only very few subscribers and/or if they are located in the customer's domestic periphery, they are also often referred to as residential gateways. The IADs and MTAs mentioned below can be designated thus.

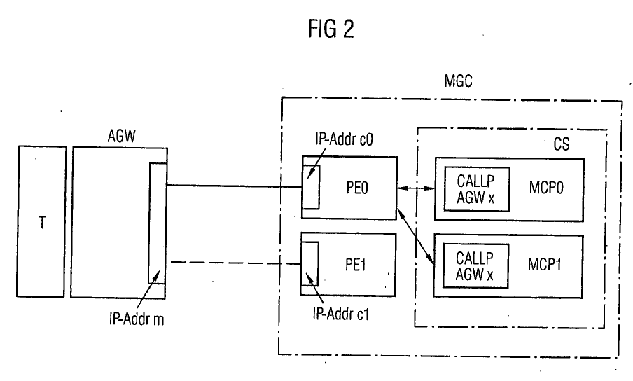

FIG. 2 shows the media gateway controller MGC in more detail. It consists of peripheral interface units or devices PE (PE0, PE1) having access to the physical packet-based, for example IP-based, interface, and of further units, referred to as the core system CS, which, inter alia, are responsible for call controlling, useful-channel controlling, charge accounting, and the operator interface etc. All the components of the media gateway controller MGC are for reasons of reliability generally of redundant design.

An access gateway AGW basically logs on after power-on to the media gateway controller MGC. The H.248 protocol's connection data (H.248 Association Handle) is exchanged between the access gateway AGW and the media gateway controller MGC as part of said logging-on. Normal switching traffic for the totality of trunks or subscribers assigned to this signaling relationship then starts. The media gateway controller MGC can at any time tell the access gateway AGW to use another media gateway controller MGC, whereupon reregistering of the access gateway AGW with the assigned terminations takes place at the specified controller.

To prevent long equivalent switchover times if one of the peripheral devices of the media gateway controller MGC fails, it is inventively provided for the access gateway AGW to log on during power-on or restart simultaneously to the peripheral device PE0 and peripheral device PE1 of the media gateway controller MGC for the same totality of subscribers. A first packet address of the peripheral device PE0 and a second packet address of the peripheral device PE1 are used for these two mutually associated registering operations. Registering on both the peripheral devices PE0 and PE1 of the media gateway controller MGC can be performed by the H.248 Service Change Restart command for a totality of subscribers while the access gateway AGW is starting up. There are comparable commands for other packet-based protocols such as H.323, SIP, or SIP-T.

The media gateway controller MGC then decides on the basis of configuration data and further possibly dynamic criteria that either the peripheral device PE0 or the peripheral device PE1 is to be active in switching terms for the plurality (totality) of subscribers. It is assumed according to the present exemplary embodiment that this is to be the peripheral device PE0. That having been established, the media gateway controller MGC will convey all subscriber signaling data and signaling data for useful-channel controlling to the access gateway AGW via the peripheral device PE0 and the protocol interface logged on via said device.

However, the above having been established, only the peripheral device PE0 will be ready to receive and hence process the subscriber signals of the access gateway AGW and messages for useful-channel controlling. The peripheral device PE1 will neither convey subscriber signals or useful-channel signals to the access gateway AGW nor process or positively acknowledge thence coming subscriber signals or useful-channel signals. Standard-compliant operation of the access gateway AGW by the packet-based switching center is thus ensured in this case of standard operation.

It is assumed now in the following that the previously activated peripheral device PE0 fails. Its failure results in fast equivalent switchover to the peripheral device PE1 of the media gateway controller MGC, which device notifies said failure to the access gateway AGW by conveying messages relevant to switching. The latter gateway interprets having received said messages relevant to switching via this protocol interface as a switchover criterion and will henceforth send its signaling messages that are switching-related and relevant to the useful channel likewise via the protocol interface belonging to the peripheral device PE1. A standard-compliant message that is to be evaluated explicitly as a changeover criterion and which is used exclusively as a changeover criterion can additionally be produced optionally by the peripheral device PE1. Said message can preferably be, for example, an audit/status-inquiry command produced by the peripheral devices PE solely for the purpose of controlling the switchover of the access gateway AGW.

The audit/status-inquiry command serves as an explicit trigger and can be, for example, an Audit Value command of the H.248 protocol, which command is to be interpreted specifically as a switch-to-active command. H.248 Audit Value commands, to be acknowledged by the access gateway AGW, are for example likewise sent at a lower frequency on the second protocol interface to the peripheral device PE1. By acknowledging, the media gateway controller MGC ensures that the operator will be promptly alerted if the redundant protocol interface fails and that possibly non-effected equivalent switchover to the peripheral device PE1 will not be carried out.

Having already been established via the peripheral device PE1, the protocol interface for accessing the same totality of subscribers can immediately communicate actively with the access gateway AGW. The peripheral device PE1 does not need to wait until failure of the peripheral device PE0 has been detected by the access gateway AGW and the packet network's specific protection time in the order of 30 s has elapsed. The subscriber signals and the signals for useful-channel controlling are conveyed upon changeover to the peripheral device PE1 toward the access gateway AGW via the standard-compliant protocol interface previously not used for switching purposes.

Having lost contact with the peripheral device PE0 owing to a failure, the access gateway AGW will attempt to cyclically log on to it at certain intervals via the second, formerly active protocol interface. It will continue doing so until successful following a repair. Once repaired, the peripheral device PE0 will acknowledge logging-on of the access gateway AGW via the protocol interface to the peripheral device PE0. However, said interface will not then be switched to become active in switching terms. Only the peripheral device PE1 will continue to be receptive for subscriber signals of the access gateway AGW and messages for useful-channel controlling and to process these. The peripheral device PE0 will neither convey subscriber signals or useful-channel signals to the access gateway AGW nor process or positively acknowledge thence coming subscriber signals or useful-channel signals.

A returning of switching operations to the peripheral device PE0 will not take place because of the risk of losing connections in the process of being established and features in stable connections, and because no other advantages will as a rule ensue from doing so. If there are requirements to avoid standby units, then load sharing for standard operation can be achieved by assigning at least two intrinsically redundant interfaces to possibly different AGWs to the two peripheral devices PE0 and PE1. If that is the desired situation for standard operation, then the associated AGW interface must be switched back to the PE0 when the PE0 has been repaired. That is possible from the viewpoint of the method, but from the viewpoint of the possibly affected connections it is disadvantageous.

An embodiment of the invention provides for the redundant protocol interface not to be monitored. The associated protocol data can instead be replicated in the media gateway controller MGC and stored there in a failsafe manner so to be reusable when the peripheral device PE1 has been repaired.

Cyclic auditing can optionally be performed on the protocol interface that is respectively not active in switching terms for monitoring whether said protocol interface is still active and for initiating remedial measures. Said auditing will allow the access gateway AGW and media gateway controller MGC to inform the operator of lost interface redundancy ahead of a potential equivalent switchover measure. This can also be used by the access gateway AGW as a decision criterion for switching over to a further packet-based switching center.

If communication via the protocol interface not being used in switching terms has broken down and changeover to a further media gateway controller MGC at the instigation of the access gateway AGW has not taken place, then the access gateway AGW will attempt to cyclically reregister with the associated peripheral device PE, with, if it is successful, the data and addresses of the protocol interface then again being exchanged between the access gateway AGW and addressed peripheral device PE.

Some IP protocols such as H.248 and H.323 do not, by definition, allow the network element acting as the media gateway controller MGC to convey messages to non-registered terminals or gateways or, as the case may be, the AGW to become active in switching terms for a further controller (gatekeeper) without the availability and consent of the controller (gatekeeper) with which it is registered. An AGW-driven changeover will be forced thereby which, if only one protocol interface is used, must in the present scenario of redundant peripheral devices having different packet addresses perforce result in downtimes of the subscribers at the AGW.

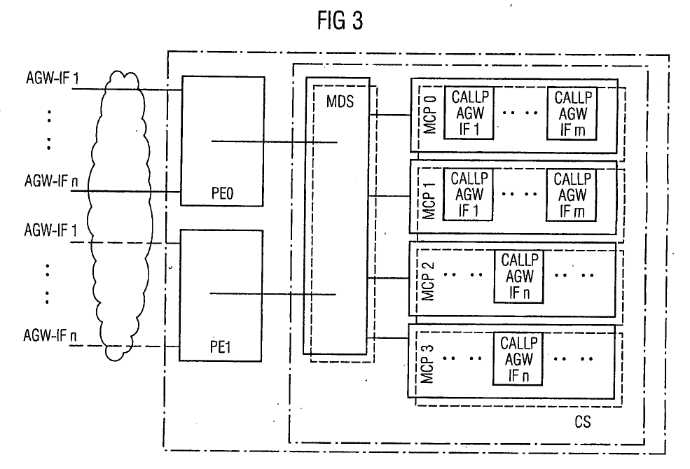

Reference is finally made to FIG. 3, showing the linking of a plurality of access gateways AGW-IF1 . . . AGW-IFn to a media gateway controller MGC.

1.-11. (canceled)

12. A method for controlling a communication gateway having a plurality of lines via a first peripheral device and a second peripheral device, comprising:
registering for a first packet-based signaling connection with the first device by the gateway, wherein the first connection is active in switching terms for all of the lines;
registering for a second packet based signaling connection with the second device by the gateway wherein the second connection is not active,
wherein the lines are selected from the group consisting of: subscriber lines, trunk lines, and combinations thereof,
whereby the non-accessibility or non-operability of the lines is minimized during a switchover from the first device to the second device.

13. The method according to claim 12, wherein each device has a different Internet Protocol (IP) address.

14. The method according to claim 13, wherein the devices are mutually redundant.

15. The method according to claim 14, wherein the devices are arranged within a Media Gateway Controller (MGC).

16. The method according to claim 12, wherein registrations occur during power-on of the gateway.

17. The method according to claim 16, wherein the registrations are substantially simultaneous.

18. The method according to claim 12, wherein a load sharing operation is provided by the signaling connection for each port.

19. The method according to claim 12, wherein the gateway is selected from the group consisting of: a trunk gateway, access gateway, and a media gateway.

20. The method according to claim 12, wherein the gateway receives a message on the second connection to indicate a switchover to the second device.

21. The method according to claim 20, wherein the message is a standard-compliant message that is used exclusively for a switchover, and wherein the gateway evaluates the message as a switchover.

22. The method according to claim 12, wherein a reliability of the linking of the gateway is increased by exchanging cyclical test messages between the gateway and the devices via a corresponding operator alerting.
